(19) United States
(12) Patent Application Publication
(10) Pub. No.: US 2010/0238415 A1
(43) Pub. Date: Sep. 23, 2010

(54) PROJECTION DISPLAY APPARATUS AND LIGHT SOURCE COOLING METHOD

(75) Inventor: Takanao KOMORI, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/694,581

(22) Filed: Jan. 27, 2010

(30) Foreign Application Priority Data
Mar. 23, 2009 (JP) 2009-069366

(51) Int. Cl. G03B 21/16; F21V 29/02

(52) U.S. Cl. 353/57; 362/373

(57) ABSTRACT

A projection display apparatus includes: a light source; a light source control unit that controls starting and shutting-off of the light source; a cooling air generator that generates cooling air for cooling the light source in a selective manner in accordance with the degree of cooling capability expressed in a plurality of levels; and a cooling control unit that instructs the cooling air generator to generate cooling air having a degree of cooling capability higher than that at a regular level in response to the situation in which the light source control unit fails to start the light source.

### BACKGROUND OF THE INVENTION

1. Field of the Invention

The present invention relates to a projection display apparatus that displays a projection image and a light source cooling method suitably used with the projection display apparatus.

2. Description of the Related Art

In recent years, a liquid crystal projector has been widely known as a projection display apparatus that displays a projection image. A liquid crystal projector is configured to form an optical image according to an image signal by using a liquid crystal panel to modulate the light emitted from a light source and enlarge, project, and display the optical image through a projection lens on a screen.

The light source used in such a liquid crystal projector is typically a discharge lamp (such as a xenon lamp, a metal-halide lamp, and a high-pressure mercury lamp). A discharge lamp of this type is, however, known not to restart after the lamp is shut off but is still hot.

To address the problem, there has been a proposal to configure a liquid crystal projector in such a way that whether or not the lamp can be restarted, whether or not the lamp should be cooled, and other decisions are made based on the period having elapsed since the lamp was shut off, the temperature measured in the vicinity of the lamp, and other parameters in order to prevent in advance the lamp from failing to restart (see JP-A-2005-049860, JP-A-2004-348109, and JP-A-2004-163686, for example). There has also been a proposal to configure a liquid crystal projector to include an auxiliary power source for driving a fan so that a fan for cooling the apparatus can be driven even after the lamp is shut off and the power cord is pulled out of a wall outlet (see JP-A-05-232267, for example).

### SUMMARY OF THE INVENTION

When whether or not the lamp can be restarted, whether or not the lamp should be cooled, and other decisions are made based on the elapsed period, the measured temperature, and other parameters, however, the lamp is not allowed to restart unless a predetermined period has been elapsed since the lamp was shut off, the measured temperature has lowered to a predetermined value or below, or any other condition is satisfied. That is, the lamp does not always restart quickly.

An auxiliary power source provided in the apparatus allows the lamp to restart quickly even with the power cord pulled out of a wall outlet because the auxiliary power source can be used to cool the lamp and lower the temperature thereof, but provision of the auxiliary power source disadvantageously complicates the configuration of the apparatus.

It is desirable to provide a projection display apparatus and a light source cooling method capable of restarting a lamp quickly without complicating the configuration of the apparatus.

According to an embodiment of the invention, there is provided a projection display apparatus including a light source, a light source control unit that controls starting and shutting-off of the light source, a cooling air generator that generates cooling air for cooling the light source in a selective manner in accordance with the degree of cooling capability expressed in a plurality of levels, and a cooling control unit that instructs the cooling air generator to generate cooling air having a degree of cooling capability higher than that at a regular level in response to the situation in which the light source control unit fails to start the light source.

In the thus configured projection display apparatus, the cooling air generator generates cooling air having a degree of cooling capability higher than that at the regular level in response to the failure in starting the light source. That is, the cooling air having a high degree of cooling capability accelerates the cooling of the light source, as compared to a case where cooling air corresponding to the regular level is used.

The “in response to failure in starting the light source” means that the following operation is carried out at the latest by a timing triggered by the failure in starting the light source. Therefore, the degree of cooling capability may be raised at a timing triggered by the failure in starting the light source, or the degree of cooling capability may be raised before the timing described above (specifically, a timing in between the activation of the apparatus and the failure in starting the light source).

The “degree of cooling capability” means how much the light source is cooled, more specifically, the amount of decrease in temperature per unit time. The degree of cooling capability is identified, for example, by the flow rate of the cooling air. The degree of cooling capability can alternatively be identified by a factor other than the flow rate of the cooling air.

The “regular level” refers to one level of cooling capability, among the plurality of levels, that is regularly used when the apparatus is activated (excluding the level at which the highest degree of cooling capability is achieved among the plurality of levels).

According to the invention, since the cooling of the light source is accelerated in response to the failure in starting the light source, the light source can restart more quickly than in a case where the cooling is carried out at the regular level with not accelerated cooling.

Further, since the degree of cooling capability may be raised in response to the failure in starting the light source, no auxiliary power source is necessary in the apparatus. Moreover, if the light source does not fail to start, the light source may be cooled at the cooling capability at the regular level, and no massive noise suppression mechanism, power supply mechanism, and other mechanisms are necessary. As a result, restarting the light source quickly does not lead to a complicated configuration of the apparatus.

### BRIEF DESCRIPTION OF THE DRAWINGS

FIG. 1 is a descriptive diagram showing an exemplary schematic configuration of a liquid crystal projector;

FIG. 2 is a descriptive diagram showing an exemplary configuration of an optical system unit in a three-panel liquid crystal projector;

FIG. 3 is a diagrammatic view showing another exemplary schematic configuration of the optical system unit in a three-panel liquid crystal projector;

FIG. 4 is a function block diagram showing an exemplary configuration of a key portion of the liquid crystal projector according to an embodiment of the invention;

FIGS. 5A to 5D are timing charts showing exemplary processes in an ordinary mode in the liquid crystal projector according to the embodiment of the invention;

FIG. 6 diagrammatically shows a specific example of difference in degree of cooling capability; and

FIGS. 7A to 7D are timing charts showing exemplary processes in an accelerated cooling mode in the liquid crystal projector according to the embodiment of the invention.

### DESCRIPTION OF THE PREFERRED EMBODIMENTS

A form according to which the invention is implemented (hereinafter referred to as an “embodiment”) will be described below. The description will be made in the following order:

1. Exemplary schematic configuration of projection display apparatus
2. Exemplary configuration of key portion of projection display apparatus
3. Exemplary processes in projection display apparatus

### <1. Exemplary Schematic Configuration of Projection Display Apparatus>

A schematic configuration of a projection display apparatus will first be described.

The description will be made with reference to a case where the projection display apparatus is a liquid crystal projector.

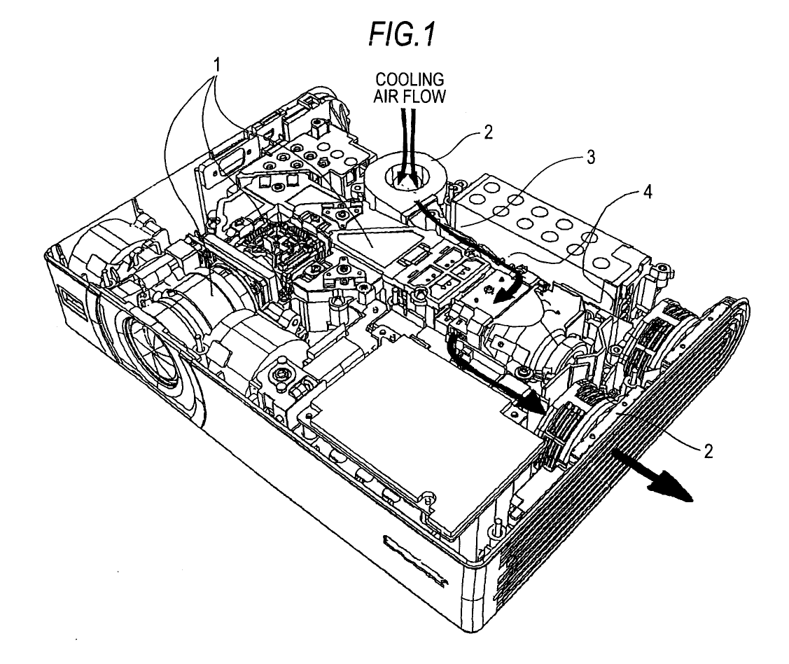

FIG. 1 is a descriptive diagram showing an exemplary schematic configuration of a liquid crystal projector.

As illustrated, the liquid crystal projector includes in a housing thereof an optical system unit 1, a cooling fan motor 2, a cooling duct 3, and a light source unit 4.

The optical system unit 1 projects and displays a color image on a screen.

The cooling fan motor 2 is, for example, formed of a sirocco fan motor or an axial fan motor, and generates air flow in order to suck air into the housing, use the sucked air to cool the light source unit 4, and discharge the cooling air out of the housing.

The cooling duct 3 guides the air sucked into the housing to the light source unit 4 and also guides the air having undergone a heat exchanging process in the light source unit 4 to the atmosphere outside the housing. That is, the cooling duct 3 functions as a cooling air guide path.

The light source unit 4 includes a light source that emits light used to display a projection image. The light source is a xenon lamp, a metal-halide lamp, a high-pressure mercury lamp, or any other suitable high-intensity discharge lamp (hereinafter simply referred to as a “light source lamp”).

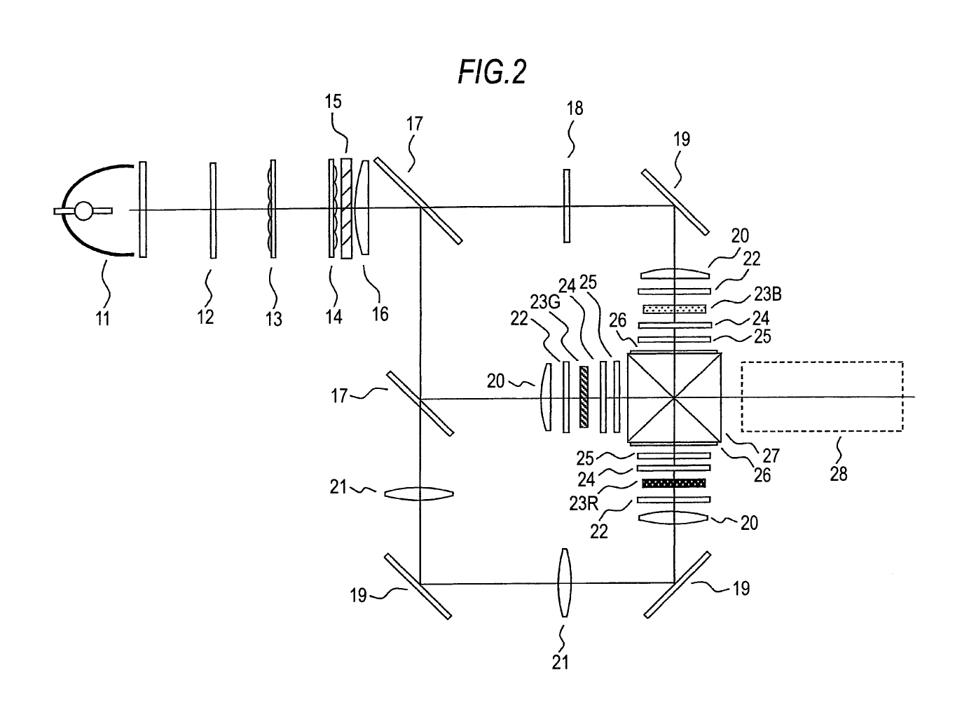

FIG. 2 is a descriptive diagram showing an exemplary configuration of the optical system unit 1 in a three-panel liquid crystal projector. FIG. 2 shows an exemplary configuration of the optical system unit 1 in a liquid crystal projector using transmissive liquid crystal panels.

In the illustrated optical system unit 1, the light emitted from a light source lamp 11 in the light source unit 4 passes through a filter 12 that eliminates infrared light and ultraviolet light, a first fly-eye lens 13, a second fly-eye lens 14, a polarization conversion element 15, and a collector lens 16. The light having passed through the above components is incident on dichroic mirrors 17, each of which reflects only the light having a specific wavelength band, and hence separated into RGB color component light beams. Part or all of the RGB color component light beams pass through or are reflected off as necessary a filter 18 that absorbs ultraviolet light, total reflection mirrors 19, condenser lenses 20, relay lenses 21, and other optical components and are incident on liquid crystal panels 23R, 23G, and 23B provided in correspondence with the RGB colors. Each of the liquid crystal panels 23R, 23G, and 23B is provided with a light incident-side polarizer 22, an optical compensator 24, and a light exiting-side polarizer 25. The color component light beams having passed through the light incident-side polarizers 22 are incident on the respective liquid crystal panels 23R, 23G, and 2313, and the color component light beams modulated by the respective liquid crystal panels 23R, 23G, and 23B pass through the optical compensators 24 and the light exiting-side polarizers 25. After the liquid crystal panels 23R, 23G, and 23B perform light modulation according to a video signal, the color component light beams having undergone the light modulation pass through half-wave films 26 as necessary, are combined in a dichroic prism 27, and are enlarged and projected through a projection lens 28. The optical system unit 1 thus projects and displays a color image on the screen.

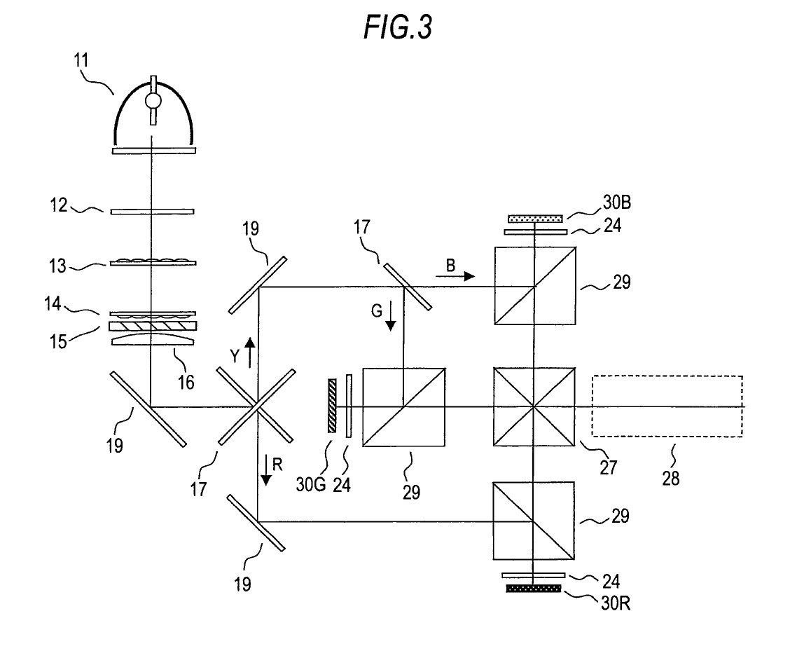

FIG. 3 is a diagrammatic view showing another exemplary schematic configuration of the optical system unit 1. FIG. 3 shows an exemplary configuration of the optical system unit 1 in a liquid crystal projector using reflective liquid crystal panels.

In the optical system unit 1 illustrated in FIG. 3 as well, the light emitted from the light source lamp 11 passes through the filter 12, the first fly-eye lens 13, the second fly-eye lens 14, the polarization conversion element 15, and the collector lens 16, as in the case where transmissive liquid crystal panels are used (see FIG. 2). The light having passed through the above components is incident on the dichroic mirrors 17, which separate the light into RGB color component light beams. Thereafter, the color component light beams pass through or are reflected off the total reflection mirrors 19, polarizing beam splitters (PBS) 29, and quarter-wave plates 24 as necessary and are incident on reflective liquid crystal panels 30R, 30G, and 30B provided in correspondence with the RGB colors. The reflective liquid crystal panels 30R, 30G, and 30B perform light modulation according to a video signal, and the color component light beams having undergone the light modulation are combined in the dichroic prism 27 and enlarged and projected through the projection lens 28. The optical system unit 1 thus displays a color image on the screen.

### <2. Exemplary Configuration of Key Portion of Projection Display Apparatus>

The configuration of a key portion of the projection display apparatus will be described.

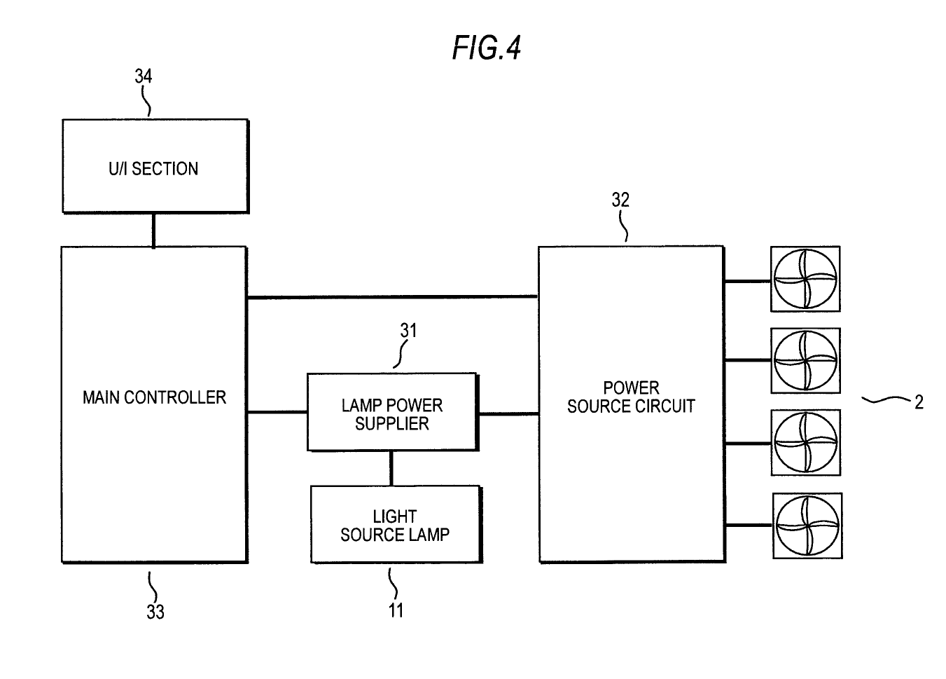

FIG. 4 is a function block diagram showing an exemplary configuration of a key portion of the liquid crystal projector.

As illustrated, the liquid crystal projector further includes a lamp power supplier 31, a power source circuit 32, a main controller 33, and a user interface (hereinafter abbreviated as “U/I”) 34.

The lamp power supplier 31 is formed of a ballast circuit that drives and controls the light source lamp 11 in the light source unit 4, and controls starting and shutting-off of the light source lamp 11 by supplying electric power thereto. That is, the lamp power supplier 31 functions as the light source control unit in an embodiment of the invention.

The power source circuit 32 supplies electric power to the cooling fan motor 2 and the lamp power supplier 31. The cooling fan motor 2 receives the electric power supplied from the power source circuit 32 and generates cooling air flowing in the housing of the liquid crystal projector.

The cooling fan motor 2 generates the cooling air in a selective manner in accordance with the degree of cooling capability expressed in a plurality of levels. The “degree of cooling capability” used herein means how much the light source is cooled, more specifically, the amount of decrease in temperature per unit time. The degree of cooling capability is identified, for example, by the flow rate of the cooling air. The degree of cooling capability can alternatively be identified by a factor other than the flow rate of the cooling air. The following description is made based on a case where the degree of cooling capability is identified by the flow rate of the cooling air. Specifically, the power source circuit 32 switches the voltage supplied to the cooling fan motor 2 to change the operating speed of the cooling fan motor 2. In this way, the degree of cooling capability corresponds to a flow rate expressed in a plurality of levels. When a plurality of cooling fan motors 2 are present, part or all of the plurality of cooling fan motors 2 may operate at various speeds. That is, the switching may be carried out in any manner as long as how much the light source is cooled can be changed.

The power source circuit 32 and the cooling fan motor 2 driven thereby function as the cooling air generator in an embodiment of the invention that generates cooling air for cooling the light source lamp 11 in a selective manner in accordance with the degree of cooling capability expressed in a plurality of levels.

The main controller 33 functions as a computer that executes a predetermined program, and controls the operation of the overall liquid crystal projector. The operation control includes controlling the operations of the lamp power supplier 31 and the power source circuit 32. The lamp power supplier 31 and the power source circuit 32 therefore control the starting and shutting off of the light source lamp 11, the degree of cooling capability of the cooling air generated by the codling fan motor 2, and other operations under the control of the main controller 33.

The main controller 33 controls the operations of the lamp power supplier 31 and the power source circuit 32 in the following manner, the details of which will be described later. That is, the main controller 33 instructs the power source circuit 32 to generate cooling air having a degree of cooling capability higher than that at a regular level in response to a situation in which the lamp power supplier 31 fails to start the light source lamp 11. After the main controller 33 has instructed the power source circuit 32 to generate cooling air having a degree of cooling capability higher than that at the regular level, and the lamp power supplier 31 has successfully started the light source lamp 11, the main controller 33 instructs the power source circuit 32 to generate cooling air corresponding to the regular level. On the other hand, after the main controller 33 has instructed the power source circuit 32 to generate cooling air having a degree of cooling capability higher than that at the regular level, and the lamp power source supplier 31 has successively failed to start the light source lamp 11 predetermined multiple times, the main controller 33 instructs the power source circuit 32 and hence the cooling fan motor 2 to stop generating the cooling air and outputs an alarm through the U/I section 34.

The “in response to failure in starting the light source lamp” means that the following operation is carried out at the latest by a timing triggered by the failure in starting the light source lamp. Therefore, the degree of cooling capability may be raised at a timing triggered by the failure in starting the light source lamp, or the degree of cooling capability may be raised before the timing described above (specifically, a timing in between the activation of the apparatus and the failure in starting the light source lamp). The “regular level” refers to one level of cooling capability, among the plurality of levels, that is regularly used when the apparatus is activated (excluding the level at which the highest degree of cooling capability is achieved among the plurality of levels).

That is, the main controller 33 functions as the cooling control unit in an embodiment of the invention.

The U/I section 34, which is formed of an operation panel, a liquid crystal display, and other components, is operated by a user of the liquid crystal projector, whereby the user inputs information to the U/I section 34 and the U/I section 34 outputs information to the user. The information input operation performed through the U/I section 34 includes setting an ordinary mode and an accelerated cooling mode. That is, the U/I section 34 functions as the mode setting unit in an embodiment of the invention. The difference between the ordinary mode and the accelerated cooling mode will be described later.

### <3. Exemplary Processes in Projection Display Apparatus>

Exemplary processes in the projection display apparatus in the ordinary mode and the accelerated cooling mode will be described below separately.

The following description will be made with reference to a case where three levels are present as the plurality of levels of cooling capability.

One of the three levels is a level at which the cooling fan motor 2 operates at the highest possible speed, that is, a level at which the degree of cooling capability is highest. The level is hereinafter referred to as the “highest cooling level.”

Another level of the three levels is a level at which the cooling fan motor 2 is not operated, that is, a level at which The degree of cooling capability is lowest. The level is hereinafter referred to as the “lowest cooling level.”

The last one of the three levels is a level at which the cooling fan motor 2 operates at an intermediate speed (a speed faster than zero but slower than the highest possible speed), that is, a level at which the degree of cooling capability is intermediate. This level is used as the “regular level.”

### [Ordinary Mode]

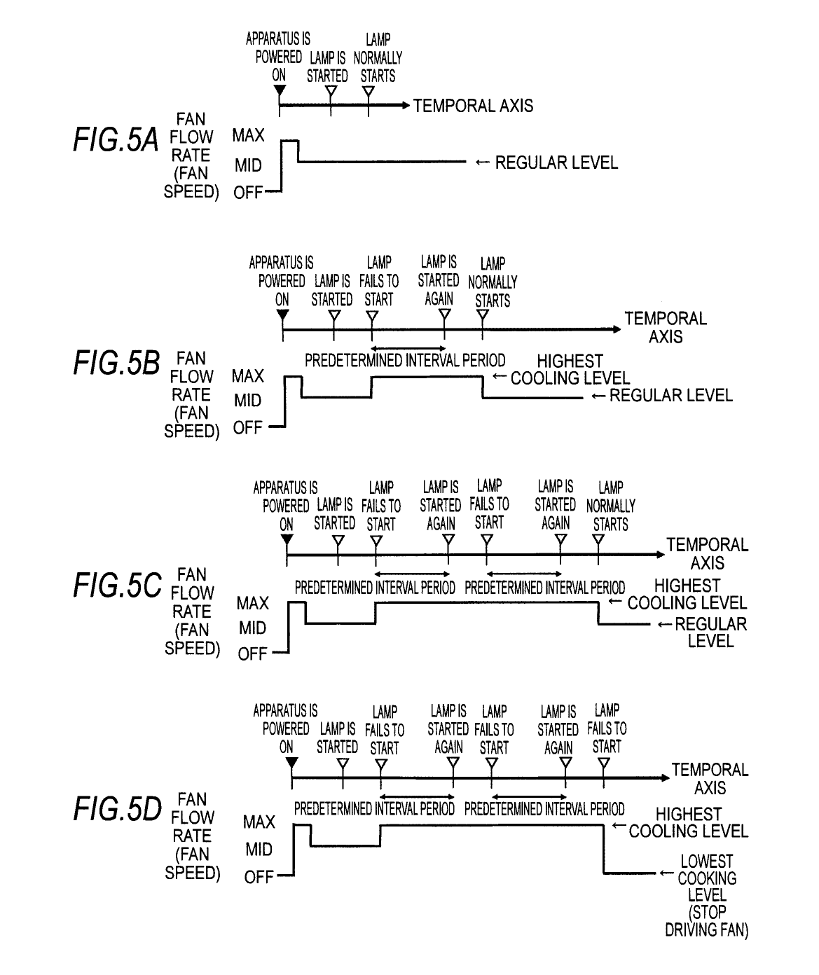

FIGS. 5A to 5D are timing charts showing exemplary processes in the ordinary mode in the liquid crystal projector.

As shown in FIG. 5A, when a power-on switch in the U/I section 34 of the liquid crystal projector is operated, the main controller 33 instructs the power source circuit 32 to operate the cooling fan motor 2. The power source circuit 32 receives the instruction and supplies electric power to the cooling fan motor 2 so that the cooling fan motor 2 generates cooling air. In this process, the power source circuit 32 temporarily operates the cooling fan motor 2 at the highest cooling level and switches the highest cooling level to the regular level after a predetermined period has elapsed since the operation started. This operation corresponds to what is called an initializing operation in which the cooling fan motor 2 is temporarily operated at the highest cooling level so that the following operation smoothly proceeds. This operation is not essential when the cooling fan motor 2 needs no initializing operation.

Thereafter, when a predetermined operation is performed through the U/I section 34 or an external apparatus connected to the liquid crystal projector inputs a signal, the main controller 33 instructs the lamp power supplier 31 to start the light source lamp 11. The lamp power supplier 31 receives the start instruction and supplies electric power to the light source lamp 11 to start the light source lamp 11.

When the light source lamp 11 has normally started, the lamp power supplier 31 notifies the main controller 33 that the light source lamp 11 has normally started. The main controller 33 receives the notification and instructs the power source circuit 32 to operate the cooling fan motor 2 at the regular level afterward.

When the light source lamp 11 has not normally started but has failed to start for some reasons, the lamp power supplier 31 notifies the main controller 33 that the light source lamp 11 has failed to start. The main controller 33 receives the notification and instructs the power source circuit 32 to operate the cooling fan motor 2 at the highest cooling level, as shown in FIG. 5B. That is, in response to the situation in which the lamp power supplier 31 has failed to start the light source lamp 11, the main controller 33 instructs the power source circuit 32 to generate cooling air at the highest cooling level, at which the degree of cooling capability is higher than that at the regular level. The power source circuit 32 receives the instruction and switches the operation of the cooling fan motor 2 from the regular level to the highest cooling level.

Thereafter, when a predetermined interval period set in advance has elapsed since the lamp power supplier 31 notified the main controller 33 that the lamp start process has failed, the main controller 33 instructs the lamp power supplier 31 to restart the light source lamp 11. The lamp power supplier 31 receives the restart instruction and starts the light source lamp 11 by supplying electric power thereto.

When the light source lamp 11 has normally started, the lamp power supplier 31 notifies the main controller 33 that the light source lamp 11 has normally started. The main controller 33 receives the notification and instructs the power source circuit 32 to operate the cooling fan motor 2 at the regular level afterward.

When the light source lamp 11 has failed to restart, the lamp power supplier 31 notifies the main controller 33 that the light source lamp 11 has failed to restart. The main controller 33 receives the notification and instructs the power source circuit 32 to keep operating the cooling fan motor 2 at the highest cooling level, as shown in FIG. 5C. The cooling fan motor 2 thus remains operating at the highest cooling level.

Thereafter, when the predetermined interval period set in advance has elapsed since the lamp power supplier 31 notified the main controller 33 that the lamp restart process has failed, the main controller 33 instructs again the lamp power supplier 31 to restart the light source lamp 11. The lamp power supplier 31 receives the restart instruction and starts the light source lamp 11 by supplying electric power thereto.

When the light source lamp 11 has normally started, the lamp power supplier 31 notifies the main controller 33 that the light source lamp 11 has normally started. The main controller 33 receives the notification and instructs the power source circuit 32 to operate the cooling fan motor 2 at the regular level afterward.

When the light source lamp 11 has failed to restart again, it is conceivable that the light source lamp 11 is, for example, defective. In consideration of this, when the lamp power supplier 31 notifies the main controller 33 that the lamp restart process has failed, the main controller 33 instructs the power source circuit 32 to stop the cooling fan motor 2, as shown in FIG. 5D. The power source circuit 32 receives the instruction and switches the operation of the cooling fan motor 2 from the highest cooling level to the lowest cooling level. That is, the main controller 33 stops driving the cooling fan motor 2 when the light source lamp 11 keeps failing to start predetermined multiple times (twice, for example).

Further, the main controller 33 outputs through the U/I section 34 an alarm indicating that the light source lamp 11 does not start. What is outputted as the alarm is not limited to a specific one as long as it is set in advance.

As described above, in the exemplary processes in the ordinary mode, the cooling fan motor 2 is driven in such a way that the cooling air at the highest cooling level, at which the degree of cooling capability is higher than that at the regular level, is generated in response to the failure in starting the light source lamp 11. As a result, the cooling air having higher cooling capability accelerates the cooling of the light source lamp 11, as compared to a case where the cooling fan motor 2 remains operating at the regular level.

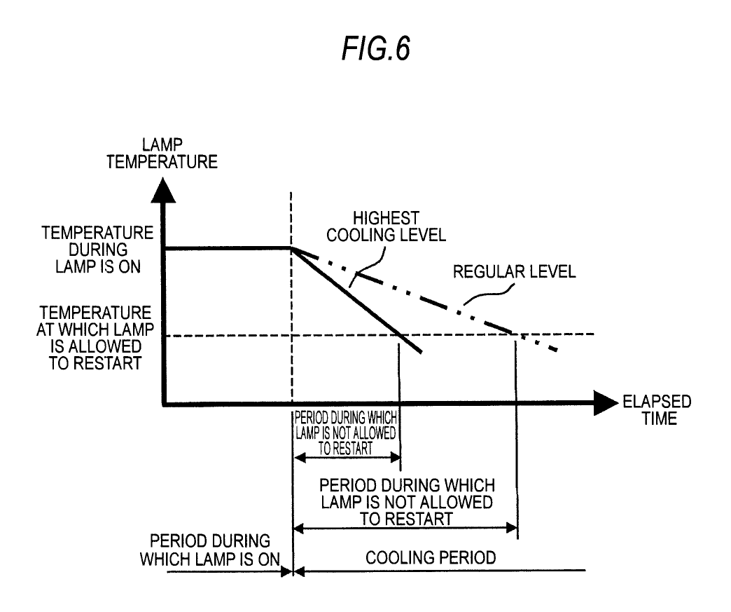

FIG. 6 diagrammatically shows a specific example of difference in degree of cooling capability.

As illustrated, when the cooling fan motor 2 operates at the highest cooling level, how much the light source lamp 11 is cooled is higher than in a case where the cooling fan motor 2 operates at the regular level. That is, the amount of decrease in temperature per unit time increases, and hence the slope in FIG. 6 indicating the rate of temperature change becomes steeper.

Therefore, provided that environmental conditions are fixed, the period during which the lamp is not allowed to restart can be shortened by operating the cooling fan motor 2 at the highest cooling level instead of operating the cooling fan motor 2 at the regular level.

This means that generating the cooling air at the highest cooling level in response to the failure in starting the light source lamp 11 allows the predetermined interval period, which is a reference used in the process of restarting the light source lamp 11, to be set at a smaller value than that in a case where the cooling fan motor 2 remains operating at the regular level.

Therefore, generating the cooling air at the highest cooling level in response to the failure in starting the light source lamp 11 allows the light source lamp 11 to restart more quickly than in the case where the cooling fan motor 2 remains operating at the regular level with no accelerated cooling. That is, the light source lamp 11 can restart in a more improved manner by performing the drive control described in the above exemplary processes.

Further, since how much the light source lamp 11 is cooled may be raised in response to the failure in starting the light source lamp 11, no auxiliary power source is necessary in the liquid crystal projector. Moreover, if the light source lamp 11 does not fail to start, the light source lamp 11 may be cooled at the cooling capability at the regular level, and no massive noise suppression mechanism, power supply mechanism, and other mechanisms are necessary. As a result, restarting the light source lamp 11 quickly does not lead to a complicated configuration of the liquid crystal projector.

Further, in the exemplary processes in the ordinary mode, after the cooling air at the highest cooling level has been generated in response to the failure in starting the light source lamp 11, and the light source lamp 11 has then successfully started, the cooling fan motor 2 is operated at the regular level. The power consumption and the noise, for example, can therefore be lowered, as compared to a case where the cooling fan motor 2 is operated at the highest cooling level all the times.

Moreover, in the exemplary processes in the ordinary mode, after the cooling air at the highest cooling level has been generated in response to the failure in starting the light source lamp 11, and the light source lamp 11 has kept failing to start predetermined multiple times, the cooling fan motor 2 is instructed to stop generating the cooling air. An alarm is then outputted to notify that the light source lamp 11 fails to start. Therefore, unnecessary attempts to restart the light source lamp 11 will not be made even when the light source lamp 11 has failed to start because the light source lamp 11 is, for example, defective, whereby the convenience for the user of the liquid crystal projector is improved.

### [Accelerated Cooling Mode]

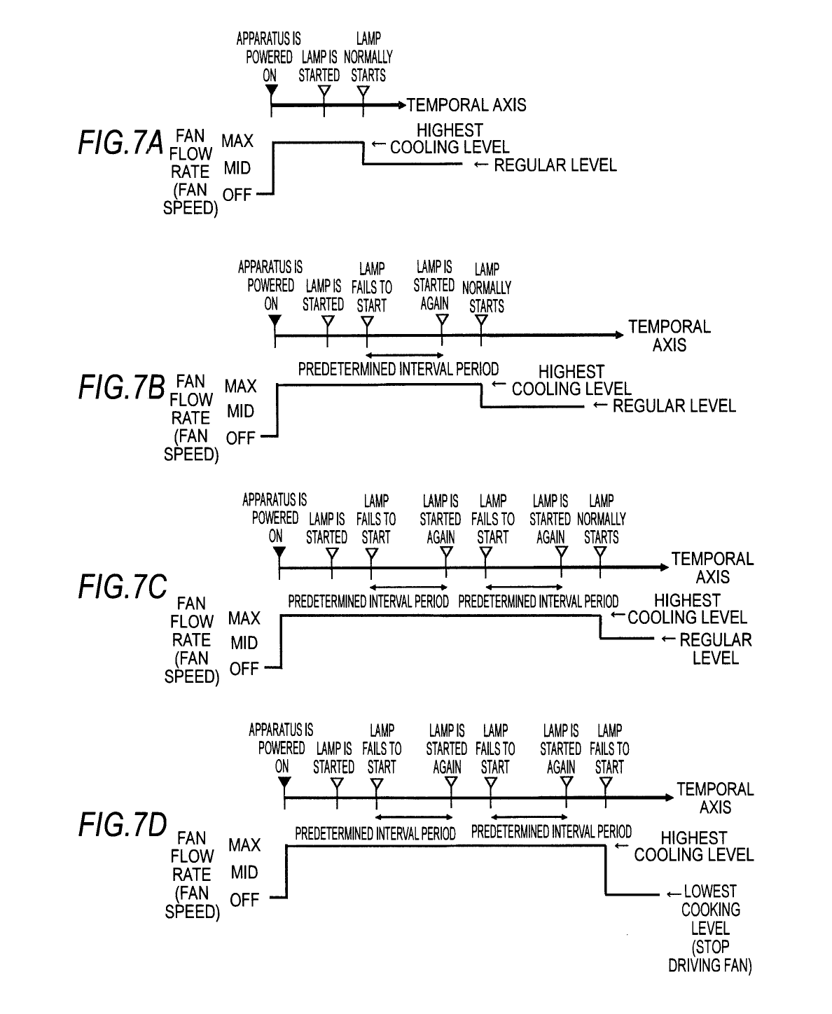

FIGS. 7A to 7D are timing charts showing exemplary processes in the accelerated cooling mode in the liquid crystal projector.

As shown in FIG. 7A, when the power-on switch in the U/I section 34 of the liquid crystal projector is operated, the main controller 33 instructs the power source circuit 32 to operate the cooling fan motor 2. The power source circuit 32 receives the instruction and supplies electric power to the cooling fan motor 2 so that the cooling fan motor 2 generates cooling air. In this process, the power source circuit 32 operates the cooling fan motor 2 at the highest cooling level.

Thereafter, when a predetermined operation is performed through the U/I section 34 or an external apparatus connected to the liquid crystal projector inputs a signal, the main controller 33 instructs the lamp power supplier 31 to start the light source lamp 11. The lamp power supplier 31 receives the start instruction and supplies electric power to the light source lamp 11 to start the light source lamp 11.

When the light source lamp 11 has normally started, the lamp power supplier 31 notifies the main controller 33 that the light source lamp 11 has normally started. The main controller 33 receives the notification and instructs the power source circuit 32 to operate the cooling fan motor 2 at the regular level afterward.

When the light source lamp 11 has not normally started but has failed to start for some reasons, the lamp power supplier 31 notifies the main controller 33 that the light source lamp 11 has failed to start. The main controller 33 receives the notification and instructs the power source circuit 32 to keep operating the cooling fan motor 2 at the highest cooling level, as shown in FIG. 7B. In this way, the cooling fan motor 2 keeps operating at the highest cooling level. That is, when the light source lamp 11 has failed to start, the main controller 33 had already instructed the power source circuit 32 to generate the cooling air at the highest cooling level, at which the degree of cooling capability is higher than that at the regular level.

Thereafter, when a predetermined interval period set in advance has elapsed since the lamp power supplier 31 notified the main controller 33 that the lamp start process has failed, the main controller 33 instructs the lamp power supplier 31 to restart the light source lamp 11. The lamp power supplier 31 receives the restart instruction and starts the light source lamp 11 by supplying electric power thereto.

When the light source lamp 11 has normally started, the lamp power supplier 31 notifies the main controller 33 that the light source lamp 11 has normally started. The main controller 33 receives the notification and instructs the power source circuit 32 to operate the cooling fan motor 2 at the regular level afterward.

When the light source lamp 11 has failed to restart, the lamp power supplier 31 notifies the main controller 33 that the light source lamp 11 has failed to restart. The main controller 33 receives the notification and instructs the power source circuit 32 to keep operating the cooling fan motor 2 at the highest cooling level, as shown in FIG. 7C. The cooling fan motor 2 thus remains operating at the highest cooling level.

Thereafter, when the predetermined interval period set in advance has elapsed since the lamp power supplier 31 notified the main controller 33 that the lamp restart process has failed, the main controller 33 again instructs the lamp power supplier 31 to restart the light source lamp 11. The lamp power supplier 31 receives the restart instruction and starts the light source lamp 11 by supplying electric power thereto.

When the light source lamp 11 has normally started, the lamp power supplier 31 notifies the main controller 33 that the light source lamp 11 has normally started. The main controller 33 receives the notification and instructs the power source circuit 32 to operate the cooling fan motor 2 at the regular level afterward.

When the light source lamp 11 has failed to restart again, it is conceivable that the light source lamp 11 is, for example, defective. In consideration of this, when the lamp power supplier 31 notifies the main controller 33 that the lamp restart process has failed, the main controller 33 instructs the power source circuit 32 to stop the cooling fan motor 2, as shown in FIG. 7D. The power source circuit 32 receives the instruction and switches the operation of the cooling fan motor 2 from the highest cooling level to the lowest cooling level. That is, the main controller 33 stops driving the cooling fan motor 2 when the light source lamp 11 keeps failing to start predetermined multiple times (twice, for example).

Further, the main controller 33 outputs through the U/I section 34 an alarm indicating that the light source lamp 11 does not start. What is outputted as the alarm is not limited to a specific one as long as it is set in advance.

As described above, in the exemplary processes in the accelerated cooling mode, the cooling fan motor 2 is driven in such a way that the cooling air at the highest cooling level, at which the degree of cooling capability is higher than that at the regular level, is generated at a timing before the light source lamp 11 fails to start. As a result, the cooling air having higher cooling capability accelerates the cooling of the light source lamp 11, as compared to the case where the cooling fan motor 2 remains operating at the regular level, as in the exemplary processes in the ordinary mode described above. That is, the light source lamp 11 can restart more quickly than in the case where the cooling fan motor 2 remains operating at the regular level with no accelerated cooling, whereby the light source lamp 11 can restart in a more improved manner.

Further, restarting the light source lamp 11 quickly does not lead to a complicated configuration of the liquid crystal projector.

Further, in the exemplary processes in the accelerated cooling mode, after the light source lamp 11 has successfully started, the cooling fan motor 2 is operated at the regular level. The power consumption and the noise, for example, can therefore be lowered, as in the exemplary processes in the ordinary mode described above.

Moreover, in the exemplary processes in the accelerated cooling mode, after the light source lamp 11 has kept failing to start predetermined multiple times, the cooling fan motor 2 is instructed to stop generating the cooling air, and an alarm is outputted. The convenience for the user of the liquid crystal projector is therefore improved, as in the exemplary processes in the ordinary mode described above.

Still further, in the exemplary processes in the accelerated cooling mode, the cooling fan motor 2 generates cooling air at the highest cooling level after the power-on switch is operated and the apparatus is activated, and keeps generating the cooling air at the highest cooling level when the light source lamp 11 fails to start. Since the cooling of the light source lamp 11 is accelerated after the apparatus is activated, it is expected that the light source lamp 11 will not fail to start. This is particularly effective, for example, when the liquid crystal projector is moved after the light source lamp 11 is shut off and the power cord is pulled out of the wall outlet, immediately after which the liquid crystal projector is activated and used.

While a preferred specific example of the invention has been described in the above embodiment, the invention is not limited thereto.

For example, while the above exemplary processes have been described with reference to the case where three levels of cooling capability are present, more levels can, of course, be present. Further, each of the levels of cooling capability is not necessarily achieved by the specific method described above in which the cooling fan motor 2 is operated at various speeds, but any suitable method may be used.

Further, for example, the above embodiment has been described with reference to the case where the projection display apparatus is a liquid crystal projector, but the invention is also applicable in the same manner to any other projection display apparatus in which the interior of the housing needs to be air-cooled, that is, an apparatus using a light modulator other than a liquid crystal panel.

As described above, the invention is not limited to what has been described in the above embodiment, but changes can be made thereto to the extent that they do not depart from the spirit of the invention.

The present application contains subject matter related to that disclosed in Japanese Priority Patent Application JP 2009-069366 filed in the Japan Patent Office on Mar. 23, 2009, the entire contents of which is hereby incorporated by reference.

What is claimed is:

1. A projection display apparatus comprising:
a light source;
a light source control unit that controls starting and shutting-off of the light source;
a cooling air generator that generates cooling air for cooling the light source in a selective manner in accordance with the degree of cooling capability expressed in a plurality of levels; and
a cooling control unit that instructs the cooling air generator to generate cooling air having a degree of cooling capability higher than that at a regular level in response to the situation in which the light source control unit fails to start the light source.

2. The projection display apparatus according to claim 1,
wherein after the cooling control unit has instructed the cooling air generator to generate cooling air having a degree of cooling capability higher than that at the regular level and the light source control unit has successfully started the light source, the cooling control unit instructs the cooling air generator to generate cooling air corresponding to the regular level.

3. The projection display apparatus according to claim 1 or 2,
wherein after the cooling control unit has instructed the cooling air generator to generate cooling air having a degree of cooling capability higher than that at the regular level and the light source control unit has kept failing to start the light source predetermined multiple times, the cooling control unit instructs the cooling air generator to stop generating the cooling air and outputs an alarm.

4. The projection display apparatus according to claim 1, 2, or 3,
further comprising a mode setting unit that sets an ordinary mode and an accelerated cooling mode,
wherein when the accelerated cooling mode is set in the mode setting unit, the cooling control unit instructs the cooling air generator to generate cooling air having a degree of cooling capability higher than that at the regular level when the apparatus is started, and sends the same instruction to the cooling air generator when the light source control unit fails to start the light source.

5. A light source cooling method comprising:
a light source control step of starting a light source;
a cooling air generation step of generating cooling air for cooling the light source in a selective manner in accordance with the degree of cooling capability expressed in a plurality of levels; and
a cooling control step of raising the degree of cooling capability of the cooling air generated in the cooling air generation step to be higher than that at a regular level in response to the situation in which the light source fails to start in the light source control step.
